(19) United States
(12) Patent Application Publication
(10) Pub. No.: US 2022/0398545 A1
(43) Pub. Date: Dec. 15, 2022

(54) INFORMATION PROCESSING APPARATUS, ENVIRONMENT SETTING SYSTEM, AND NON-TRANSITORY RECORDING MEDIUM

(71) Applicants: Kota Ogasawara, Kanagawa (JP); Toru Yamaku, Tokyo (JP)

(72) Inventors: Kota Ogasawara, Kanagawa (JP); Toru Yamaku, Tokyo (JP)

(73) Assignee: Ricoh Company, Ltd., Tokyo (JP)

(21) Appl. No.: 17/804,643

(22) Filed: May 31, 2022

(30) Foreign Application Priority Data
Jun. 11, 2021 (JP) 2021-098030

(51) Int. Cl. G06Q 10/10

(52) U.S. Cl. CPC G06Q 10/1095

(57) ABSTRACT

An information processing apparatus, an environment setting system, and a non-transitory recording medium. The information processing apparatus acquires schedule information of a user of a user terminal, classifies a schedule included in the schedule information, determines data to be provided to the user terminal based on classification of the schedule, and transmits to the user terminal, the data determined to be provided to the user terminal.

### CROSS-REFERENCE TO RELATED APPLICATIONS

This patent application is based on and claims priority pursuant to 35 U.S.C. § 119(a) to Japanese Patent Application No. 2021-098030, filed on Jun. 11, 2021, in the Japan Patent Office, the entire disclosure of which is hereby incorporated by reference herein.

### BACKGROUND

### Technical Field

The present disclosure relates to an information processing apparatus, an environment setting system, and a non-transitory recording medium.

### Related Art

Remote work has become widespread, and places where users work have been expanded to places other than company. On the other hand, users communicate with people in the company through online meetings and the like. In general, online meetings are often registered in advance in user's schedule information.

A known technique provides data based on the user's schedule information.

### SUMMARY

Embodiments of the present disclosure describe an information processing apparatus, an environment setting system, and a non-transitory recording medium. The information processing apparatus acquires schedule information of a user of a user terminal, classifies a schedule included in the schedule information, determines data to be provided to the user terminal based on classification of the schedule, and transmits to the user terminal, the data determined to be provided to the user terminal.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an outline of setting an environment;

FIG. 2 is a diagram illustrating an example of a system configuration of an environment setting system;

FIG. 3 is a block diagram illustrating examples of connection devices connected to a user terminal;

FIG. 4 is a block diagram illustrating an example of a hardware configuration of a computer;

FIG. 5 is a block diagram illustrating an example of a hardware configuration of a mobile terminal;

FIG. 6 is a block diagram illustrating an example of a functional configuration of the environment setting system;

FIG. 7 is a table illustrating an example of basic information set by a user;

FIG. 8 is a table illustrating an example of schedule information;

FIGS. 9A and 9B are diagrams illustrating examples of tag information set in environment setting data;

FIG. 10 is a diagram illustrating an example of a basic setting screen;

FIG. 11 is a diagram illustrating an example of a schedule setting screen;

FIG. 12 is a diagram illustrating an example of a content setting screen;

FIG. 13 is a diagram illustrating an example of an external device setting screen;

FIG. 14 is a table illustrating a schedule classified by a classification unit and a method of determining environment setting data set by a data determination unit;

FIG. 15 is a table illustrating an example of an association between priority of the schedule and the environment setting data;

FIGS. 16A and 16B are diagrams illustrating a method of providing the environment setting data with a relaxation tag;

FIG. 17 is a diagram illustrating a method of providing the environment setting data with the relaxation tag;

FIG. 18 is a sequence diagram illustrating an example of an overall operation of the environment setting system; and

FIG. 19 is a flowchart illustrating a process for setting the environment by the environment setting system.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, as an example of the embodiment for carrying out the present disclosure, an environment setting system and a data providing method performed by the environment setting system are described with reference to the drawings.

In recent years, remote work has become widespread, and places where users work have been expanded to places other than a company. Users now work in various locations such as homes, shared offices, and cafes. For this reason, meetings are held online, and online meetings in which users at each location hold meetings through a network have become common.

In the case a user works in a space occupied by an individual, the user can set the space freely, for example, play favorite music through a speaker, or burn favorite incense.

However, each user is to set the environment each time, which is troublesome for the user. For example, the user is to set a schedule for providing sound, image, illumination, or scent in time for the online meeting.

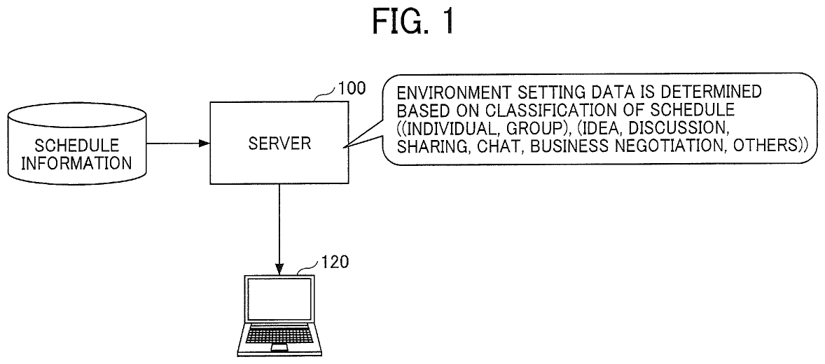

In the present embodiment, the environment setting system automatically sets the environment based on the user's schedule. An outline is described with reference to FIG. 1.

FIG. 1 is a diagram illustrating the outline of setting the environment according to the present embodiment. A server 100 refers to schedule information of the user and determines environment setting data to be provided based on a classification of a schedule included in the schedule information. The server 100 provides the determined environment setting data at scheduled time.

An example of a method of classifying the schedule is to classify based on whether a schedule indicates work by an individual or work by a group of people. In this case, the server 100 changes a kind of environment setting data to be provided depending on whether the schedule indicates individual work or group work.

Further, the server 100 classifies the schedule based on the content of the schedule. Schedules are classified into, for example, ideas, discussions, sharing, chats, business negotiations, etc., depending on the content. The server 100 changes the kind of environment setting data and a genre of the environment setting data to be provided according to the classification based on the content of the schedule.

As described above, the environment setting system of the present embodiment determines the environment setting data based on the classification of the schedule included in the schedule information and provides the determined environment setting data to the user at scheduled time. Since the schedule is classified according to whether the schedule indicates the individual work or the group work and the content of the schedule, the environment setting system can provide the environment setting data suitable for the schedule.

The environment is an outside world that surrounds human and affects human senses. The environment setting data is data processed by a user terminal or an external device to set the environment. Environments include sound, illumination, scents, and images.

Schedule information is a calendar or a schedule in which events and plans are written in a time of a day.

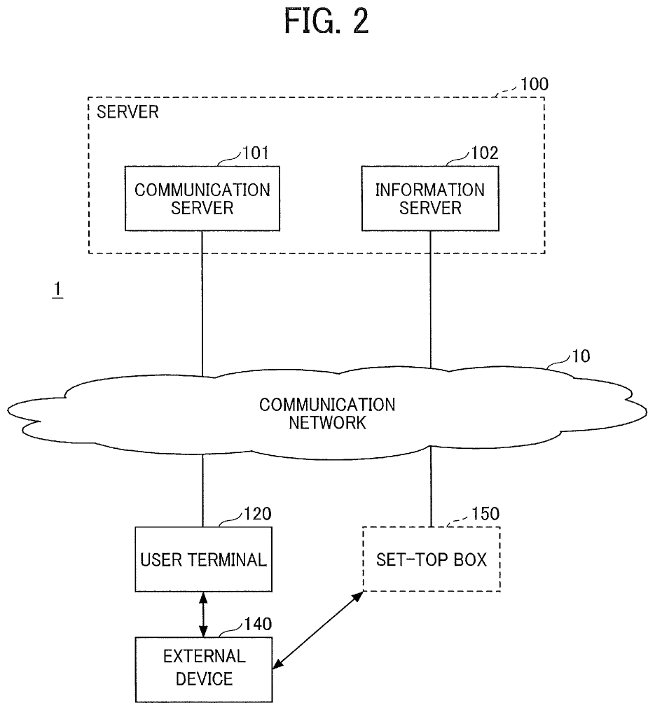

FIG. 2 is a diagram illustrating an example of a system configuration of the environment setting system according to the present embodiment. The environment setting system 1 includes, for example, a communication server 101, an information server 102, and one or more user terminals 120, which are communicably connected to each other through a communication network 10. The environment setting system 1 may include a plurality of user terminals 120 and a plurality of external devices 140.

The one or more user terminals 120 are, for example, information processing apparatuses such as a personal computer (PC), a tablet terminal, or a smartphone. The user terminal 120 functions as the user terminal 120 by, for example, starting an application for the environment setting system 1 in a user terminal mode. The application communicates with the communication server 101 and receives data used to set the environment (hereinafter referred to as environment setting data).

The communication server 101 is a computer or a system including a plurality of computers.

As an example, the communication server 101 communicates with one or more user terminals 120 and sets the environment according to the user's schedule. The communication server 101 includes a function as a web server, generates screen information for the user to make various settings, and transmits screen information to the user terminal 120. The screen information is a program described in HyperText Markup Language (HTML), Extensible Markup Language (XML), a script language, and Cascading Style Sheet (CSS). The structure of the web page is mainly specified by HTML, the operation of the web page is specified by the script language, and the style of the web page is specified by CSS.

Further, the communication server 101 manages an online meeting by transmitting and receiving data such as sound, video, and application display screens for the meeting between a plurality of user terminals 120. The online meeting is an example of a session managed by the communication server 101. The sessions managed by the communication server 101 are not limited to the online meeting, and may include various sessions such as online lectures, online medical examinations, online games, and online parties. Here, as an example, the following description is given assuming that the session is the online meeting.

The session refers to communication for transmitting and receiving various data between the plurality of user terminals 120. The session is connected (or established) at some point and then disconnected (or released). By connecting to the same session, the plurality of user terminals 120 transmit and receive various data to and from each other.

The information server 102 is a computer or a system including a plurality of computers, and stores various information (schedule information, basic settings described below, etc.) used in the environment setting system 1. OFFICE 365 (registered trademark), GOOGLE CALENDAR (registered trademark), and the like are known as the information server 102 that manages the schedule, but the schedule may be managed in any other way.

The information server 102 may be an external web service, cloud system, storage server, or the like of the environment setting system 1. Further, the communication server 101 and the information server 102 may be one server 100. In the following description, the communication server 101 and the information server 102 are simply referred to as “server 100” as long as the two servers are not distinguished. The server 100 is an information processing system having one or more information processing apparatuses.

Each of the one or more user terminals 120 is connected to the external device 140. The user terminal 120 includes a function of receiving the environment setting data and controlling the environment around the user terminal 120 by using the external device 140 based on the received environment setting data. A speaker or the like of the user terminal 120 may be used as a substitute for the external device 140.

Further, a set-top box 150 may be connected to the communication network. The set-top box 150 is registered in the server 100 in advance in association with the user ID. The set-top box 150 receives the environment setting data and transmits the environment setting data to the external device 140. Accordingly, the user terminal 120 is able to reduce communication delay and the like, for example, by not receiving and transmitting the environment setting data with content in relation to meeting. The set-top box 150 and the external device 140 communicate by wireless communication such as BLUETOOTH (registered trademark) or wireless local area network (LAN), or by wired communication such as a dedicated line or wired LAN. Further, the set-top box 150 and the external device 140 may be integrated into one device.

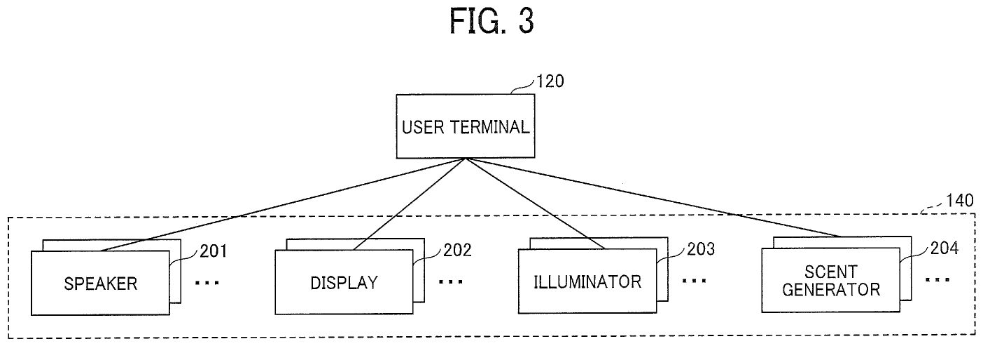

FIG. 3 illustrates examples of the external devices 140 connected to the user terminal 120. In FIG. 3, examples of the external devices 140 include one or more speakers 201, one or more displays 202, one or more illuminators 203, and one or more scent generators 204.

The one or more speakers 201 output, for example, sound representing the environment. Here, the sound representing the environment may include various sound such as sound of rain, sound of wind, a song of bird, a murmur of a stream, sound of vehicle, and noise. As a preferred example, the user terminal 120 may output the sound representing the environment from the one or more speakers 201 by using a high resolution sound source (High Resolution Audio) having a higher sound quality than the sound of the meeting in order to enhance a sense of presence.

One or more displays 202 display an image representing the environment. As a preferred example, the user terminal 120 may display a landscape or the like on one or more window-style displays 202 or may display a painting or the like on a picture frame-style display 202. Further, the user terminal 120 may display an aquarium fish or the like on an aquarium-style display 202 or may display the sky or the like on the display 202 provided on a ceiling.

One or more illuminators 203 change, for example, brightness or hue of surroundings of the user terminal 120 according to control from the user terminal 120.

One or more scent generators 204 change a kind and intensity of a generated scent according to the control from the user terminal 120.

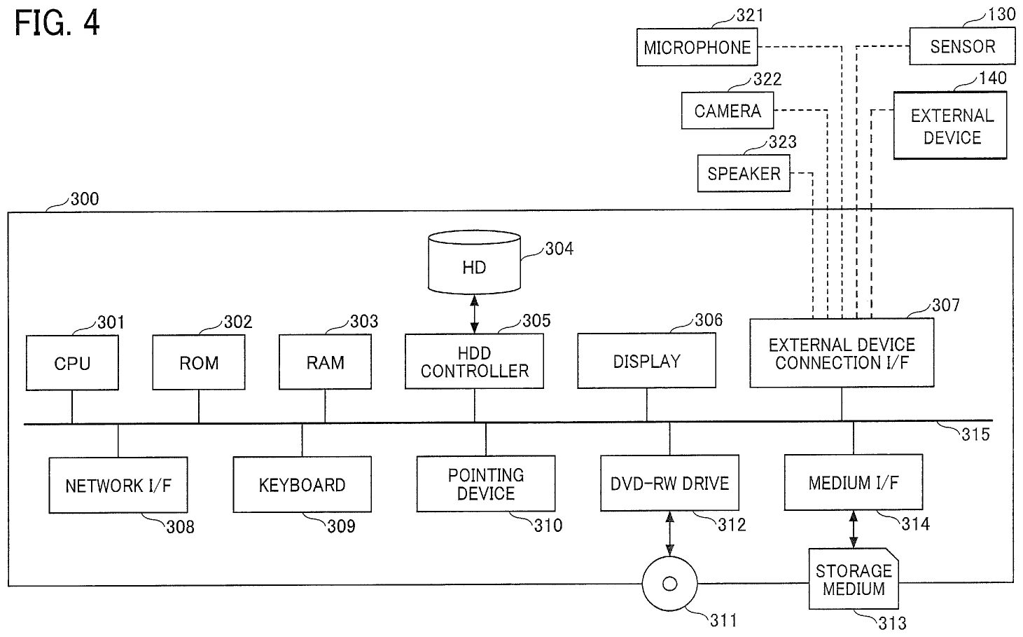

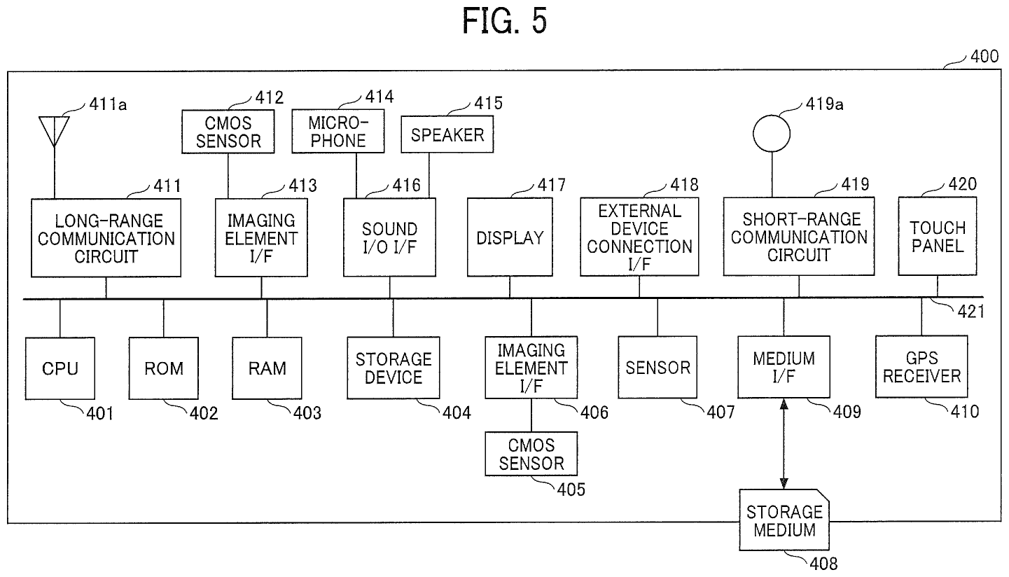

The server 100 has, for example, a hardware configuration of a computer 300 as illustrated in FIG. 4. Alternatively, the server 100 is implemented by a plurality of computers 300. Further, the user terminal 120 has, for example, the hardware configuration of the computer 300 as illustrated in FIG. 4 or a hardware configuration of the mobile terminal 400 as illustrated in FIG. 5.

FIG. 4 is a block diagram illustrating the hardware configuration of the computer 300, according to embodiments of the present disclosure. The computer 300 includes, for example, a central processing unit (CPU) 301, a read only memory (ROM) 302, a random access memory (RAM) 303, a hard disk (HD) 304, a hard disk drive (HDD) controller 305, a display 306, an external device connection interface (I/F) 307, a network I/F 308, a keyboard 309, a pointing device 310, a digital versatile disk rewritable (DVD-RW) drive 312, a medium I/F 314, a bus line 315, and the like.

Among these elements, the CPU 301 controls entire operation of the computer 300. The read only memory (ROM) 302 stores programs used for driving the computer 300, such as an initial program loader (IPL). The RAM 303 is used, for example, as a work area of the CPU 301. The HD 304 stores various data such as a control program.

The HDD controller 305 controls reading or writing of various data from and to the HD 304 according to the control of the CPU 301.

The display 306 displays various information such as a cursor, menu, window, character, or image. The external device connection I/F 307 is an interface for connecting various external devices. For example, when the computer 300 is the user terminal 120, the external device connection I/F 307 is connected to a microphone 321 that acquires sound of the online meeting, a camera 322 that captures video of the online meeting, a speaker 323 that outputs sound of the online meeting, and the like. The microphone 321 and the camera 322, the speaker 323, and the like may be provided inside the computer 300. In the case the computer 300 is the user terminal 120, the external device 140 or the like described with reference to FIG. 3 is connected to the external device connection I/F 307.

The network I/F 308 is an interface for communicating with another computer 300 or the like using the communication network 10. The keyboard 309 is an example of an input device provided with a plurality of keys for allowing the user to input characters, numerals, or various instructions. The pointing device 310 is an example of the input device that allows the user to select or execute a specific instruction, select a target for processing, or move a cursor being displayed.

The DVD-RW drive 312 reads and writes various data from and to a DVD-RW 311, which is an example of a removable storage medium. The DVD-RW 311 is not limited to the DVD-RW and may be another recording medium. The medium I/F 314 controls reading or writing (storage) of data from or to a storage medium 313 such as a flash memory or a memory card. The bus line 315 includes an address bus, a data bus, various control signals, and the like for electrically connecting each of above components.

FIG. 5 is a block diagram illustrating an example of a hardware configuration of the mobile terminal 400 according to the present embodiment. As illustrated in FIG. 5, the mobile terminal 400 includes a CPU 401, a ROM 402, a RAM 403, a storage device 404, a complementary metal oxide semiconductor (CMOS) sensor 405, an imaging element I/F 406, a sensor 407, a medium I/F 409, a Global Positioning System (GPS) receiver 410, and the like.

Among these elements, the CPU 401 controls the operation of the entire mobile terminal 400 by executing a program. The ROM 402 stores, for example, programs used to drive the mobile terminal 400 such as the IPL. The RAM 403 is used as a work area for the CPU 401. The storage device 404 is a large-capacity, non-volatile storage device implemented by, for example, a solid state drive (SSD), a flash ROM, or the like, and stores an operating system (OS), a program such as an application, and various data.

The CMOS sensor 405 is a built-in imaging device that acquires image data by imaging a subject (mainly a self-portrait) under the control of the CPU 401. The mobile terminal 400 may include an imaging device such as a charge coupled device (CCD) sensor instead of the CMOS sensor 405. The imaging element I/F 406 is a circuit that controls a drive of the CMOS sensor 405. The sensor 407 is a variety of sensors such as an electronic magnetic compass, a gyro compass, and an acceleration sensor that detect the geomagnetism. The medium I/F 409 controls reading or writing (storage) of data from or to a storage medium 408 such as a flash memory. The GPS receiver 410 receives a GPS signal from a GPS satellite.

The mobile terminal 400 further includes a long-range communication circuit 411, an antenna 411a of the long-range communication circuit 411, a CMOS sensor 412, an imaging element I/F 413, a microphone 414, a speaker 415, a sound input/output (I/O) I/F 416, a display 417, an external device connection I/F 418, a short-range communication circuit 419, an antenna 419a of the short-range communication circuit 419, and a touch panel 420.

The long-range communication circuit 411 communicates with other devices through, for example, a communication network 10. The CMOS sensor 412 is an example of a built-in imaging device configured to capture a subject under control of the CPU 401 to obtain image data. The imaging element I/F 413 is a circuit that controls driving of the CMOS sensor 412. The microphone 414 is a built-in circuit that converts sound into an electric signal. The speaker 415 is a built-in circuit that generates sound such as music or voice by converting an electric signal into physical vibration. The sound I/O I/F 416 is a circuit that processes sound wave signal input and output between the microphone 414 and the speaker 415 according to the control from the CPU 401.

The display 417 is a display such as a liquid crystal display or an organic electro luminescence (EL) for displaying an image of a subject, various icons, and the like. The external device connection I/F 418 is an interface for connecting various external devices. The short-range communication circuit 419 performs various short-range wireless communication. The external device 140 described with reference to FIG. 3 is connected to the mobile terminal 400 through the external device connection I/F 418 or the short-range communication circuit 419. The touch panel 420 is an example of an input device that allows the user to operate the mobile terminal 400 by touching a screen of the display 417.

The mobile terminal 400 further includes a bus line 421. The bus line 421 includes an address bus, a data bus, and various control signals, etc., for electrically connecting the elements illustrated in FIG. 5.

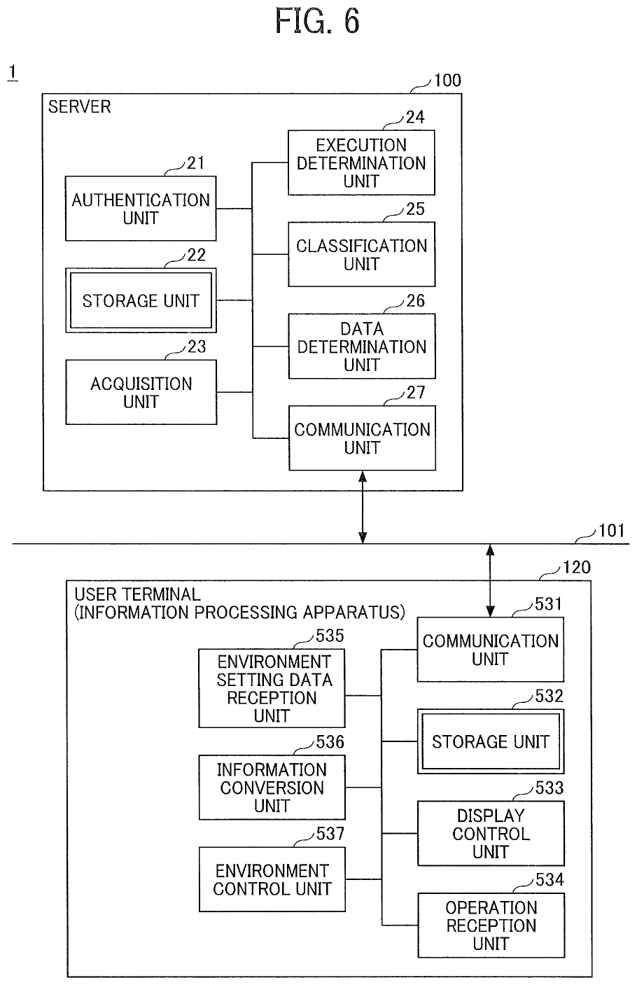

FIG. 6 is a block diagram illustrating an example of a functional configuration of an environment setting system 1.

The server 100 includes an authentication unit 21, a storage unit 22, an acquisition unit 23, an execution determination unit 24, a classification unit 25, a data determination unit 26, a communication unit 27, and the like by the CPU 301 executing a program stored in one or more memories included in the server 100. Note that at least a part of the above functional units may be implemented by hardware. Further, the server 100 implements the storage unit 22 by a program executed by the CPU 301, the HD 304, the HDD controller 305, and the like.

The communication unit 27 connects the server 100 to the communication network 10 by using, for example, the network I/F 308 of FIG. 4, and executes a communication process for communicating with another device.

The authentication unit 21 executes, for example, an authentication process for authenticating a user (or an information processing apparatus) who uses the information processing apparatus such as the user terminal 120. For example, the authentication unit 21 determines that the user is a legitimate user when a user ID and a user password included in an authentication request transmitted from the user terminal 120 or the like are stored in advance in the server 100. Biometric authentication, an integrated circuit (IC) card, or the like may be used for the authentication.

The execution determination unit 24 determines the time to set the environment. That is, the execution determination unit 24 determines whether the environment may be set for an event set in the user's schedule. For example, the execution determination unit 24 determines to set the environment at the timing when basic information is updated, the timing when a new event is registered in the schedule, or the timing immediately before the start time of the basic information.

The acquisition unit 23 acquires the user's schedule information and the basic information associated with the user ID from the information server 102 and stores the information in the storage unit 22.

The classification unit 25 classifies the schedule included in the schedule information. For example, the schedule is classified according to whether an individual participates, or multiple people participate. In addition, the classification unit 25 classifies the schedule according to the content of the schedule. A detailed description is given below.

The data determination unit 26 determines the environment setting data according to the classification of the schedule. That is, the data determination unit 26 determines sound data, image data, illumination data, scent data, and the like according to the classification of the schedule. The data determination unit 26 also determines the volume of sound data, the brightness and hue of illumination data, and the kind and intensity of scent data.

The storage unit 22 stores user's schedule information, basic information when using this system, and the like. In addition, the storage unit 22 may store the sound data and the image data. The sound data and the image data may be acquired by the server 100 from an external server.

The user terminal 120 is implemented by, for example, a CPU (CPU 301 or CPU 401) executing a program stored in the memory of the information processing apparatus such as the computer 300 illustrated in FIG. 4 or the mobile terminal 400 illustrated in FIG. 5. For example, in the user terminal 120, the CPU executes an application corresponding to the environment setting system 1 stored in the memory of the user terminal 120 and implements a communication unit 531, a storage unit 532, a display control unit 533, an operation reception unit 534, an environment setting data reception unit 535, an information conversion unit 536, an environment control unit 537, and the like. Note that at least a part of the above functional units may be implemented by hardware. Further, the user terminal 120 implements a storage unit 532 by a program executed by the CPU included in the user terminal 120, a storage device included in the user terminal 120, and the like.

The communication unit 531 performs a communication process for connecting the user terminal 120 to the communication network 10 and communicating with other devices by using, for example, the network I/F 308 of FIG. 4 or the long-range communication circuit 411 of FIG. 5.

The display control unit 533 executes a display control process for displaying various display screens on a display such as the display 306 of FIG. 4 or the display 417 of FIG. 5. For example, the display control unit 533 executes a process of displaying on the display, various screens based on screen information transmitted from the communication server.

The operation reception unit 534 receives various operations by the user who uses the user terminal 120. For example, the operation reception unit 534 receives operation by the user on various operation screens displayed by the display control unit 533.

The environment setting data reception unit 535 receives, for example, the environment setting data transmitted from the server 100 or the like through the communication unit 531. The environment setting data reception unit 535 stores the received environment setting data in the storage unit 532 or the like.

When desired, the information conversion unit 536 converts the environment setting data received by the environment setting data reception unit 535 so as to be compatible with the external device 140 connected to the user terminal 120. For example, the information conversion unit 536 stores information related to the external device 140 in the storage unit 532 in advance and converts the information so as to be compatible with the data format or the program for controlling the external device 140.

The environment control unit 537 executes an environment control process for controlling the environment around the user terminal 120 based on the environment setting data received by the environment setting data reception unit 535 (converted by the information conversion unit 536). For example, the environment control unit 537 reproduces (outputs) the sound data included in the environment setting data by using one or more speakers 201 as illustrated in FIG. 3. Further, the environment control unit 537 causes one or more displays 202 as illustrated in FIG. 3 to display the image by using the image data (still image data or moving image data) included in the environment setting data. In addition, the environment control unit 537 changes the brightness, color, and the like of one or more illuminators 203 as illustrated in FIG. 3 based on the sensor data, the control data, and the like included in the environment setting data.

The storage unit 532 temporarily stores, for example, the environment setting data received by the environment setting data reception unit 535. Further, the storage unit 532 stores information related to the external device 140 connected to the user terminal 120 in advance.

Hereinafter, various information used by the server 100 for setting the environment is described. By logging in to the environment setting system 1 and setting this information in advance, the user can register the various information in association with the user ID. Based on the basic information for each user registered in the server 100 in association with the user ID, the server 100 acquires the basic information of the user by acquiring the user ID from the user terminal 120. The user ID may be, for example, an e-mail address, but may be any numerical value or a combination of alphabets.

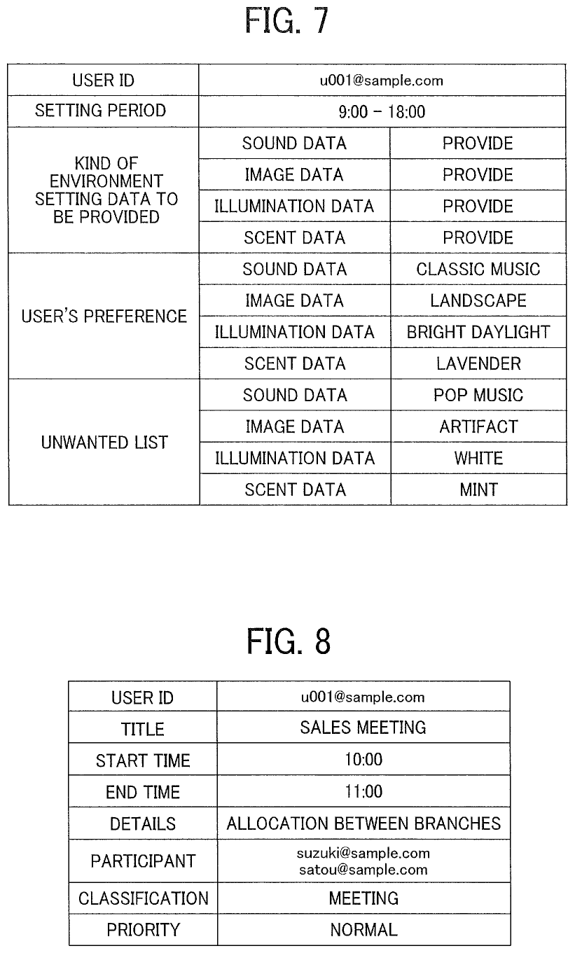

FIG. 7 is a table illustrating an example of the basic information set by the user. The basic information is information in which the user sets the basic policy of environment setting. The basic information in FIG. 7 is information that the user logs in to the server 100 and registers in advance from a web page or the like. Each item of the basic information is described in the following.

A setting period indicates a time zone in which the environment setting system 1 sets the environment. The environment setting system 1 sets the environment for the schedule within the setting period.

A kind of environment setting data to be provided is set by the user as to what kind of environment setting data the user desires in setting the environment. Examples of the kinds of environment setting data include sound data such as music, image data such as images and videos, illumination data which is information about brightness, and scent data which is information about scent. A specific device is to be installed in the user's environment to process the illumination data or scent data.

A user's preference is information regarding the user's preference for each kind of environment setting data (corresponding to the genre of data and regarded as tag information described below). The data determination unit 26 selects the environment setting data desired by the user by selecting the option that suits the preference of the user set in advance. For example, in the case of sound data, in response to a selection of classical music by the user, the data determination unit 26 selects the classical music and transmits to the user terminal 120 as the environment setting data. The sound data includes classical music, pop music, ambient music such as sound of rain, western music, and anime song. The user can also set the volume of the sound data.

The image data includes paintings, geometric patterns, etc., in addition to landscapes. The illumination data includes lamp color, white light, and the like, in addition to the daylight color. The user can also set the brightness and hue of the illumination data. The scent data includes lavender, citrus fruits, eucalyptus, etc. in addition to mint. The user can also set the strength of the scent data.

The unwanted list indicates a genre that the user does not want to be provided contrary to the preference. The environment setting data of unwanted list will not be provided.

However, in the present embodiment, the environment setting data is determined according to the classification of the schedule, not according to the preference of the user. When setting is made to prioritize the user's preference over the environment setting data according to the classification of the schedule, the user's preference is taken into consideration.

FIG. 8 is a table illustrating an example of the schedule information. The schedule information is stored in association with the user ID. The schedule information is a calendar in which the year, date, day of the week, etc. are indicated and the user inputs the schedule by designating the date and time. By inputting the schedule, the content input by the user is displayed in the calendar corresponding to the date and time in the calendar.

In addition to storing in the information server 102, the schedule information may be stored locally in the user terminal 120. In this case, in response to the user logging in to the environment setting system 1, the schedule information locally stored in the user terminal 120 is transmitted to the server 100.

Each item of the schedule information is described in the following.

A title is the name of the meeting. The name of the meeting may be input by the user or may be selected from a list.

Start time is the time when the meeting is scheduled to start, and end time is the time when the meeting is scheduled to end.

Details are agenda and the like to be discussed at the meeting.

Participants are user IDs (email addresses) of the users who are planning to attend the meeting.

Classification is information for indicating which classification the schedule belongs. Examples of the classification includes “movement”, “meeting”, “individual learning”, “report”, “regular”, “divergence”, “idea”, “discussion”, “sharing”, “chat”, “business negotiation”, etc. The user selects the classification corresponding to the schedule from the options.

Priority is information indicating priority of the schedule. Examples of the priority include “low”, “normal”, “high” and the like. The user selects the priority corresponding to the schedule from the options.

FIG. 8 illustrates schedule of a meeting as an example, but, for example, a schedule of a work to be executed by an individual may be set.

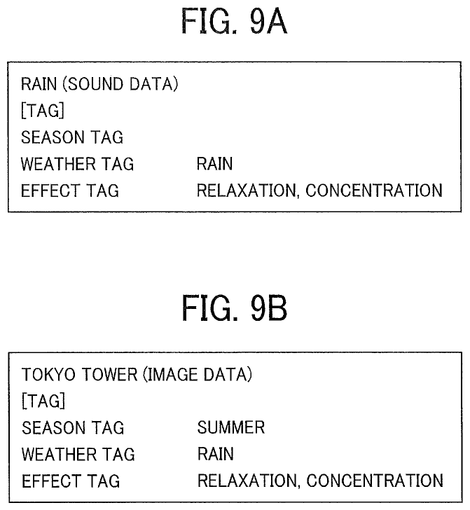

FIGS. 9A and 9B are examples of tag information set in the environment setting data. FIG. 9A is an example of the tag information of the sound data, and FIG. 9B is an example of the tag information of the image data. The tag information includes a seasonal tag, a weather tag, an effect tag, and the like. In the sound data of FIG. 9A, “rain” is set as the weather tag, “relaxation” and “concentration” are set as the effect tags, and the sound data matching the user's preference set by the user in the basic information is provided. In the image data of FIG. 9B, “summer” is set as the seasonal tag, “rain” is set as the weather tag, “relaxation” and “concentration” are set as the effect tags, and the image data matching the user's preference set by the user in the basic information is provided.

As for the environment setting data other than the sound data, the data determination unit 26 may automatically select the environment setting data having the same weather tag and seasonal tag as the sound data.

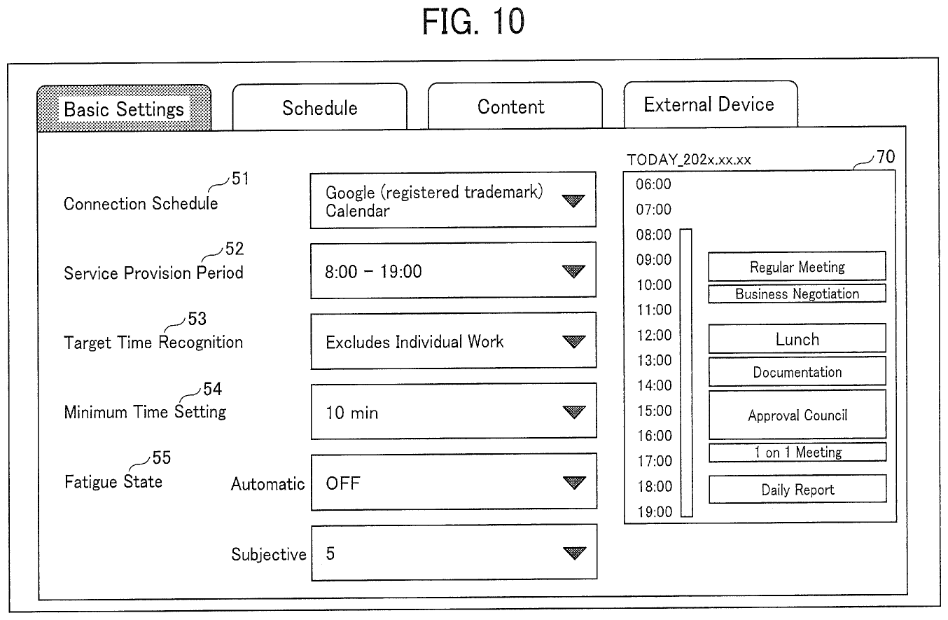

Examples of a setting screen for the basic information and the like is described with reference to FIGS. 10 to 13. The setting screens are switched with tabs. FIG. 10 is a diagram illustrating an example of the basic setting screen. Each item on the basic setting screen is described in the following.

A connection schedule 51 switches management method of the schedule, for example, managed online by GOOGLE CALENDAR (registered trademark) or locally managed by an editor 70. The connection schedule is set by the user.

A service provision period 52 corresponds to the basic information setting period, and the user sets the start time and the end time.

Target time recognition 53 is an item for setting whether individual work is included in a specific schedule such as the meeting. In the present embodiment, the target time recognition 53 is not referred to.

Minimum time setting 54 is an item in which the minimum time of a schedule for setting the environment is set. The environment setting data is not provided for a schedule shorter than the time set in the minimum time setting 54.

The fatigue state 55 is effective when the user terminal 120 detects the user's fatigue state with a device such as a camera. To detect the fatigue state from the facial expression of the user, the automatic fatigue state 55 is to be set to ON. To detect the fatigue state subjectively by the user, the user selects the fatigue state for detection numerically.

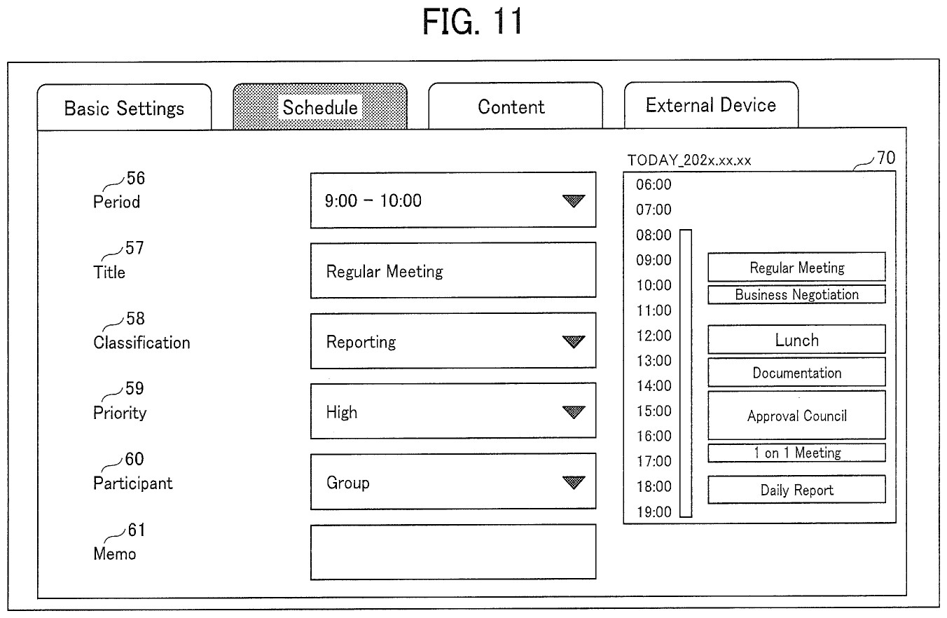

FIG. 11 is an example of a schedule setting screen. Each item on the schedule setting screen is described in the following. FIG. 11 illustrates a case where the content of the schedule is operated by an individual.

A period 56 is the time for the schedule. In FIG. 11, a period from 9:00 to 10:00 is selected.

A title 57 is a title of the schedule.

Classification 58 is an item for selecting the classification of the schedule from the list (“movement”, “meeting”, “individual learning”, “report”, “regular”, “divergence”, “idea”, “idea”, “discussion”, “sharing”, “chat”, “business negotiation”, etc.).

Priority 59 is an item for selecting the priority of the schedule (low, normal, high).

A participant 60 is an item for selecting whether the participant is the individual or the group. The user can also directly enter or select the participant. In this case, whether the participant is the individual or the group is automatically set.

A memo 61 is an item in which the user stores any information.

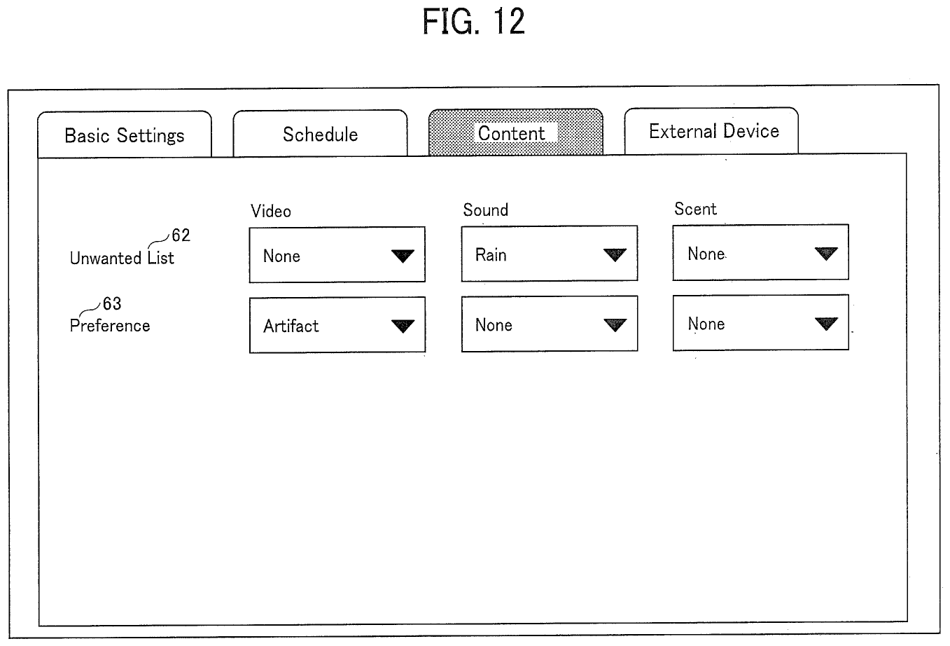

FIG. 12 is a diagram illustrating an example of a content setting screen. Each item on the content setting screen is described in the following.

The user selects the genre to be set in the unwanted list 62 and the genre to be set in the preference 63 for each item of the environment setting data which are the image, sound, and scent. The genre corresponds to the user's preference (tag information) in the basic information. The genres set in the unwanted list 62 are to be excluded from the environment setting data. The genres set in the preference 63 are to be preferentially used for environment setting data.

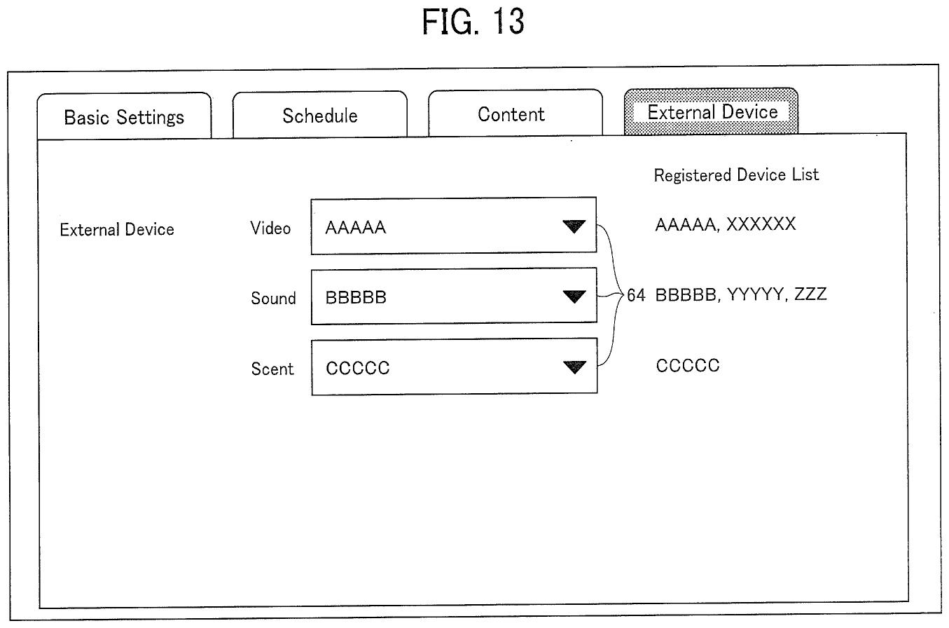

FIG. 13 is a diagram illustrating an example of an external device setting screen. Each item on the external device setting screen is described in the following. The user selects by pull-down menus 64, the external device for video, the external device for sound, and the external device for scent from the external devices displayed on the screen. The external device selected by the user is stored in the storage unit 22. In FIG. 13, a list of registered devices is displayed. A device driver of the selected external device is installed, and the user terminal 120 controls the external device 140.

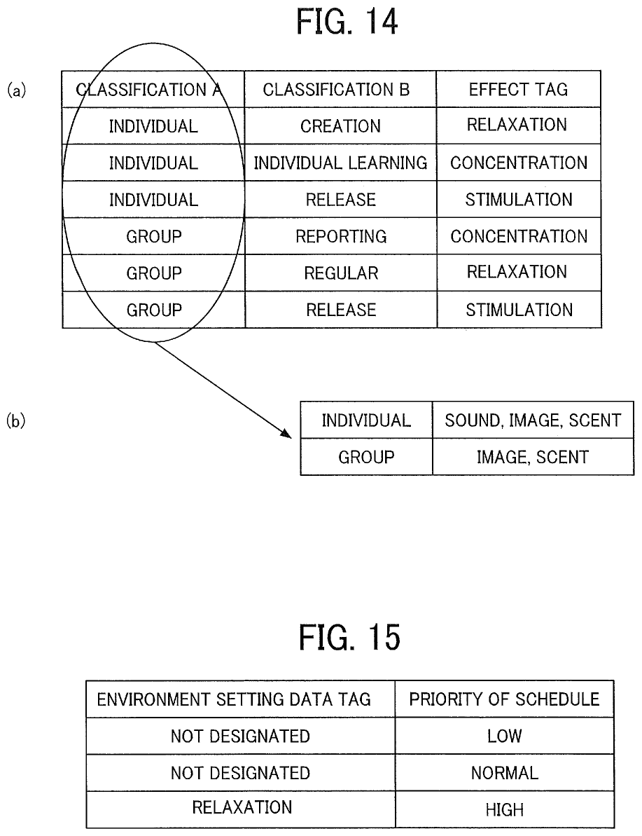

FIG. 14 is a table illustrating a schedule classified by the classification unit 25 and a method of determining environment setting data set by the data determination unit 26. FIG. 14(a) is an example of a data determination table referred to when the data determination unit 26 sets the data. Classification A indicates whether the schedule is carried out by the individual or by the group. Classification B is an example of the content of the schedule. The classification unit 25 determines the classification A from the item of the participant in the schedule information. Further, the classification unit 25 classifies the content of the schedule from the classification of the schedule information. The classification unit 25 may determine from the title of the schedule information.

In the data determination table, an effect tag is associated with the classification results of the schedule (classification A, classification B). That is, the data determination unit 26 determines the environment setting data from whether the schedule is of the individual or of the group and the content of the schedule. The data determination unit 26 determines the kind and tag information of the environment setting data according to the classification of the schedule and provides the determined environment setting data.

Further, as illustrated in FIG. 14(b), the kind of environment setting data to be provided is set depending on whether the schedule is of the individual or of the group (classification A). From the table of FIG. 14(b), the data determination unit 26 determines the kind of environment setting data to be provided. The environment setting data determined by the data determination unit 26 may not be provided in the case the kind of environment setting data is not set to “provide” in the “kind of environment setting data to be provided” in the basic information. Further, the genre (tag information) in this case is selected based on the “user's preference” in the basic information.

The data determination table in FIG. 14 is an example. The data determination table may be set by the user in advance or may be prepared in advance. Further, the data determination table may be prepared by machine learning. A learning device learns the correspondence between the user's schedule and the environment setting data manually set by the user at the scheduled time.

Further, as illustrated in FIG. 15, the data determination unit 26 may determine the tag information of the environment setting data according to the priority of the schedule. FIG. 15 is a diagram illustrating association between the priority of the schedule and the tag information of the environment setting data. As illustrated in FIG. 15, the classification unit classifies the schedule based on the priority of the schedule, and the data determination unit 26 determines the tag information of the environment setting data according to the priority (low, normal, high).

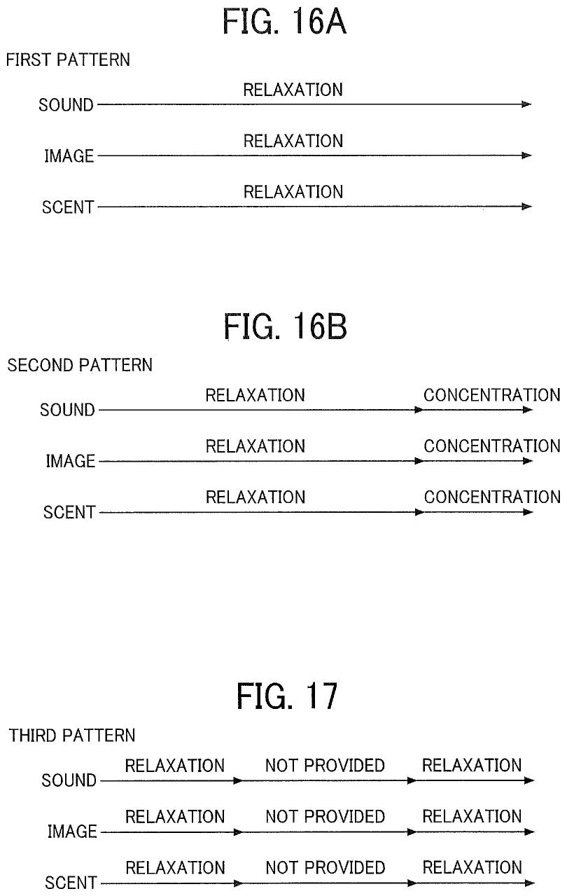

FIGS. 16A, 16B, and 17 are diagrams illustrating methods of providing environment setting data with the relaxation tag. Three patterns of environment setting data tagged with relaxation are described in the following.

FIG. 16A illustrates a first pattern. Horizontal axes of FIG. 16A represent passage of time of a schedule. The environment setting data with the relaxation tag is selected from the sound data, the image data, and the scent data respectively. In the first pattern, the environment setting data with the relaxation tag is continuously provided.

FIG. 16B illustrates a second pattern. In the second pattern, in addition to the tag determined according to the classification of the schedule, some percentage of the environment setting data of other tags are included. For example, in the case the environment setting data with the relaxation tag (an example of the first data) is set, environment setting data with a concentration tag different from the relaxation tag (an example of the second data) is set. In FIG. 16B, the sound data, image data, and scent data are simultaneously switched from relaxation to concentration. This allows the environment to change naturally. Further, the sound data, the image data, and the scent data may be switched from relaxation to concentration at different timing. A combination of relaxation and concentration is an example, and relaxation and stimulation may be combined.

FIG. 17 illustrates the third pattern. In the third pattern, the sound data, the image data, and the scent data are provided in the order of relaxation, nothing is provided, and relaxation. The environment setting data is intermittently provided with a period during which the environment setting data is not provided in between. Further, the sound data, the image data, and the scent data may be stopped at different timing.

The first to third patterns are examples of methods of providing the environment setting data. The pattern of providing the environment setting data is preferred to be set by the user in the basic information in advance. Further, the user may be able to set a desired pattern.

In addition, in the case the tag determined according to the classification of the schedule is a tag set as unwanted by the user in the basic information, the data determination unit 26 does not select the environment setting data set as unwanted.

As described on the basic setting screen, the user's health condition (fatigue state, drowsiness, etc.) is input or analyzed. The data determination unit 26 sets environment setting data based on the health condition. For example, in the case the degree of user's fatigue state is high, the data determination unit 26 changes from highly stimulating environment setting data to highly relaxing environment setting data.

Alternatively, the user terminal 120 may take an image of the user with a camera or the like, and the user terminal 120 may analyze the health condition or the like from the image. The data determination unit 26 changes the environment setting data to provide according to the analyzed health condition. As a method of estimating the health condition from a face image or the like, methods using machine learning and artificial intelligence (AI) are available.

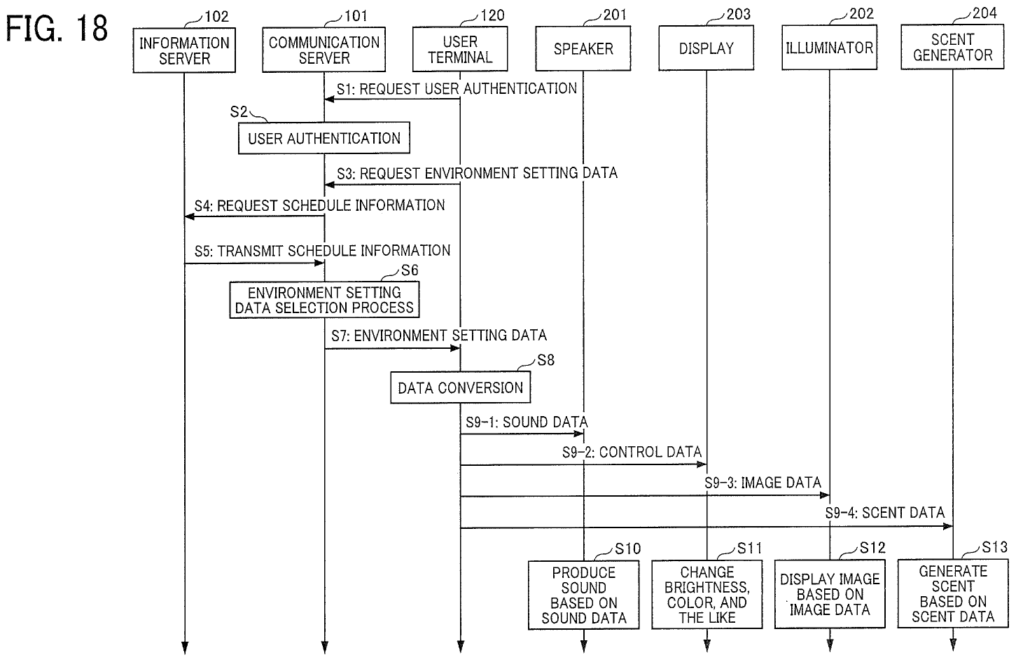

FIG. 18 is a sequence diagram illustrating an example of an overall operation of the environment setting system.

In step S1, the user operates the user terminal 120 and inputs a user ID and password. The operation reception unit 534 of the user terminal 120 receives the input, and the communication unit 531 sends an authentication request (user ID, password) to the communication server.

In step S2, the communication unit 27 of the communication server 101 receives the authentication request and the authentication unit 21 authenticates the user by a known method. Authentication may be performed by an authentication server. Here, it is assumed that the authentication is successful.

In step S3, the communication unit 531 of the user terminal 120 requests the environment setting data from the communication server. The request may be made automatically by the application or may be made by the user.

In steps S4 and S5, the acquisition unit 23 of the communication server 101 acquires the schedule information associated with the user ID of the logged-in user from the information server 102.

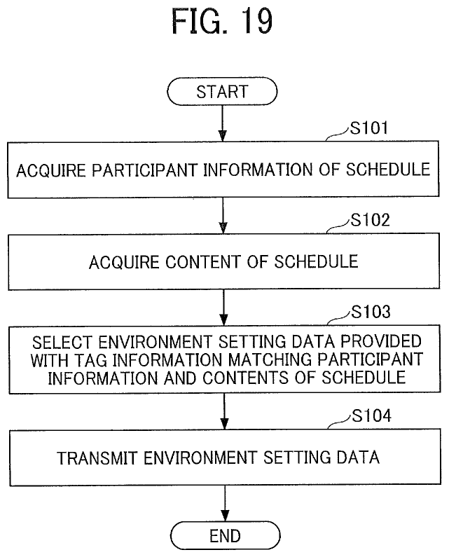

In step S6, the classification unit 25 classifies the schedule in the schedule information, and the data determination unit 26 determines the environment setting data to be provided according to the classification. The details of this process are described with reference to FIG. 19.

In step S7, the communication unit 27 of the communication server 101 transmits the environment setting data to the user terminal 120.

In step S8, the communication unit 531 of the user terminal 120 receives the environment setting data and the information conversion unit 536 converts the environment setting data into an appropriate data format so that the data can be processed by the user terminal 120 and the external device 140. For example, the illumination data including illuminance, brightness, and saturation are converted into commands corresponding to the Application Programming Interface (API) of the illuminator 203. For example, in the case of image data, the streaming data is converted into a video signal to be displayed by the display 202. Alternatively, the environment setting data may not be converted.

In steps S9-1 to S9-4, the environment control unit 537 transmits the converted data to each external device 140 and controls by control information. Alternatively, the environment control unit 537 transmits and controls the converted data based on the information regarding the provision period included in the environment setting data.

In steps S10 to S13, the speaker 201 reproduces the sound data, the illuminator 203 changes the illuminance, brightness, and saturation of the illumination, the display 202 displays the image data, and the scent generator 204 generates the scent. Further, in the case the data can be processed by the user terminal 120 such as the image data and sound data, the processing may be performed by the user terminal 120. For example, when the image data is displayed by the user terminal 120, the image is set as wallpaper. The sound data reproduced by the user terminal 120 is reproduced from the speaker 415 of the user terminal 120.

FIG. 19 is a flowchart illustrating a process for setting the environment by the environment setting system.

The process of FIG. 19 is started in response to a change in the basic information or the schedule by the user after logging in. The execution determination unit 24 detects the change in the basic information or the schedule and starts setting the environment setting data. In the case the login state of the user continues, the execution determination unit 24 starts this process at a scheduled time daily.

In step S101, the classification unit 25 acquires the participant registered in the schedule. The classification unit 25 classifies the schedule based on whether the schedule is to be carried out by the individual or by the group.

In step S102, the classification unit 25 acquires the content of the schedule. The content of the schedule is classified into the classification such as ideas, discussions, sharing, chats or business negotiations, and the priority such as low, normal, high, etc. The classification unit 25 classifies the content of the schedule into these classifications.

In step S103, the data determination unit 26 refers to the data determination table and determines the tag of the environment setting data based on the classification of the schedule. The data determination unit 26 randomly selects environment setting data in which the same tag as the selected tag is set. Further, the data determination unit 26 determines the pattern of the environment setting data at random or according to the user's setting.

In step S104, the communication unit 27 transmits the environment setting data to the user terminal 120. The communication unit 27 may transmit the environment setting data to the user terminal 120 in real time as in streaming or may transmit the environment setting data to the user terminal 120 in advance. In the case of providing in real time, as soon as the user terminal 120 receives the environment setting data, the environment setting data is processed in real time. In the case of transmitting the environment setting data to the user terminal 120 in advance, the server 100 transmits the scheduled start time and end time to the user terminal 120 together with the environment setting data.

The environment setting system of the present embodiment determines the environment setting data based on the classification of the schedule included in the schedule and provides the determined environment setting data to the user at the scheduled time.

Since the schedule is classified according to whether the schedule is to be carried out by the individual or by the group and the content of the schedule, the environment setting system can provide environment setting data suitable for the schedule.

The above-described embodiment is illustrative and do not limit the present disclosure. Thus, numerous additional modifications and variations are possible in light of the above teachings within the scope of the present disclosure. Any one of the above-described operations may be performed in various other ways, for example, in an order different from the one described above.

For example, in the present embodiment, the case where the environment is set by the server 100 has been described, but a part of the processing executed by the server 100 may be executed by the user terminal 120. For example, in the case the user terminal 120 can refer to the basic information and the schedule information, the user terminal 120 can execute the functions of the execution determination unit 24, the classification unit 25, and the data determination unit 26.

Further, the configuration example illustrated in FIG. 6 is divided according to the main functions in order to facilitate understanding of the processing by the server 100 and the user terminal 120. The present disclosure is not limited by the way of dividing the processing unit or the name. The processing of the server 100 and the user terminal 120 can be further divided into more processing units according to the processing content. Further, one process can be divided to include a larger number of processes.

The apparatuses or devices described in one or more embodiments are just one example of plural computing environments that implement the one or more embodiments disclosed herein. In some embodiments, the server 100 includes multiple computing devices, such as a server cluster. The multiple computing devices is configured to communicate with one another through any type of communication link, including a network, shared memory, etc., and perform the processes disclosed herein.

Further, the server 100 can be configured to share the processing steps disclosed in the present embodiment, for example FIG. 18, in various combinations. For example, a process executed by a given unit may be executed by a plurality of information processing apparatuses included in the server 100. Further, the server 100 may be integrated into one server or may be divided into a plurality of devices.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combination thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing apparatus comprising:
circuitry configured to:
acquire schedule information of a user of a user terminal;
classify a schedule included in the schedule information;
determine data to be provided to the user terminal based on classification of the schedule; and
transmit to the user terminal, the data determined to be provided to the user terminal.

2. The information processing apparatus of claim 1, wherein
the circuitry classifies the schedule based on whether the schedule is to be carried out by an individual or by a group of people.

3. The information processing apparatus of claim 2, wherein
the circuitry is further configured to change a kind of the data to be provided depending on whether the schedule is to be carried out by the individual or by the group of people.

4. The information processing apparatus of claim 1, wherein
the circuitry is further configured to classify the schedule based on content of the schedule.

5. The information processing apparatus of claim 4, wherein
the circuitry is further configured to change the kind of the data to be provided according to the content of the schedule.

6. The information processing apparatus of claim 1, wherein
the circuitry is further configured to:
classify the schedule based on whether the schedule is to be carried out by the individual or by the group of people and based on the content of the schedule; and
change the kind of the data to be provided depending on whether the schedule is to be carried out by the individual or by the group of people and the content of the schedule.

7. The information processing apparatus of claim 1, wherein
based on a determination of a genre of first data, the circuitry is further configured to determine to provide second data of a genre different from the genre of the first data following the first data.

8. The information processing apparatus of claim 1, wherein
based on a setting to restrict to provide a genre of the data, the circuitry is further configured to remove the data of a restricted genre from the data to be provided.

9. An environment setting system comprising:
an information processing system configured to transmit data for setting an environment to a user terminal; and
the user terminal that communicates with the information processing system, the information processing system including:
circuitry configured to:
acquire schedule information of a user of the user terminal;
classify a schedule included in the schedule information;
determine data to be provided to the user terminal based on classification of the schedule; and
transmit to the user terminal, the data determined to be provided to the user terminal.

10. A non-transitory recording medium storing a plurality of instructions which, when executed by one or more processors, causes the processors to perform a method comprising:
acquiring schedule information of a user of a user terminal;
classifying a schedule included in the schedule information;
determining data to be provided to the user terminal based on classification of the schedule; and
transmitting to the user terminal, the data determined to be provided to the user terminal.
